(19) United States
(12) Patent Application Publication
(10) Pub. No.: US 2025/0319929 A1
(43) Pub. Date: Oct. 16, 2025

(54) FRONT STRUCTURE OF VEHICLE AND METHOD FOR ASSEMBLING FRONT STRUCTURE OF VEHICLE

(71) Applicant: TOYODA GOSEI CO., LTD., Kiyosu-shi (JP)

(72) Inventors: Tomohiro KAJITANI, Aichi (JP); Jun YAMAGUCHI, Aichi (JP); Takaki ITATSU, Aichi (JP); Hiroshi TAKAKURA, Aichi (JP)

(21) Appl. No.: 19/174,143

(22) Filed: Apr. 9, 2025

(30) Foreign Application Priority Data
Apr. 11, 2024 (JP) 2024-063992

(51) Int. Cl. B62D 25/08; B60Q 1/00; B60Q 1/04; B60Q 1/068

(52) U.S. Cl. CPC B62D 25/08; B60Q 1/0041; B60Q 1/0441; B60Q 1/068

(57) ABSTRACT

A front structure of a vehicle includes a pair of headlamps each of which having a second inclined surface, an exterior member having a first inclined surface, and a support member. The support member includes: a body portion to which the exterior member is attached, a pair of attachment portions that are connected to both ends of the body portion in the vehicle width direction and to which the headlamps are attached, and a fastening portion that fastens the attachment portions to the body portion at a position where the first and second inclined surfaces are in contact with each other. The support member allows a position change of the attachment portions with respect to the body portion in the vehicle width direction in a state where the body portion and the attachment portions are not fastened by the fastening portion, and restricts the position change in a different direction.

### CROSS-REFERENCE TO RELATED APPLICATIONS

This application is based on and claims priority under 35 USC 119 from Japanese Patent Application No. 2024-63992 filed on Apr. 11, 2024, the entire content of which is incorporated herein by reference.

### TECHNICAL FIELD

The present disclosure relates to a front structure of a vehicle and a method for assembling the front structure of a vehicle.

### BACKGROUND ART

JP2009-248900A describes a lamp unit attachment structure (hereinafter, referred to as an attachment structure) of a vehicle.

The attaching structure described in JP2009-248900A includes a pair of headlamp units and a pair of receiving portions provided on a vehicle body and supporting the pair of headlamp units.

A radiator support member extending in a vehicle width direction is provided in a front portion of the vehicle. The radiator support member is provided with a pair of support portions extending downward from both ends in the vehicle width direction.

The above receiving portion is fixed to the support portion. The receiving portion includes a vertical plate portion fixed to the support portion and a horizontal plate portion protruding outward in the vehicle width direction from a lower end of the vertical plate portion. The horizontal plate portion is provided with a main hook portion protruding upward.

The headlamp unit includes a housing that opens forward and a lens that covers the opening of the housing. A plurality of lamps serving as light sources are accommodated in the housing. A lower surface of the housing is provided with a main stop portion that engages with the main hook portion.

The main stop portion of the headlamp unit is engaged with the main hook portion of the horizontal plate portion, so that the headlamp unit is assembled to the receiving portion.

In the related art, an exterior member that constitutes a part of a design surface of a front portion of a vehicle is provided between a pair of headlamp units.

### SUMMARY OF INVENTION

Incidentally, in the front structure of a vehicle including the attaching structure described in JP2009-248900A, the main stop portion provided on the headlamp unit engages with the main hook portion provided on the radiator support member. Therefore, an error in assembling the headlamp unit to the radiator support member occurs. In addition, since the exterior member is assembled to the radiator support, an assembly error between the headlamp and the exterior member may increase due to a dimensional error or the like of the exterior member. In this case, for example, an appearance of the vehicle such as symmetry in the vehicle width direction of the vehicle may be impaired.

Aspects of the present disclosure relating to a front structure of a vehicle and a method for assembling the front structure of a vehicle for addressing the above matters will be described.

(1) A front structure of a vehicle including:
a pair of headlamps provided apart from each other in a vehicle width direction;
an exterior member provided between the pair of headlamps; and
a support member located at a vehicle rear of the exterior member and configured to allow the pair of headlamps and the exterior member to be attached, in which
the exterior member has a first inclined surface that comes into contact with the pair of headlamps in the vehicle width direction,
each of the pair of headlamps has a second inclined surface that is inclined along the first inclined surface,
the first inclined surface is inclined such that a portion located more upward or more downward toward an outer side in the vehicle width direction,
the support member includes:
   a body portion to which the exterior member is attached;
   a body fixing portion that fixes the body portion to a vehicle body;
   a pair of attachment portions that are connected to both ends of the body portion in the vehicle width direction and to which the pair of headlamps are attached; and
   a fastening portion that fastens the attachment portions to the body portion at a position where the first inclined surface and the second inclined surfaces are in contact with each other, and
   the support member includes a support mechanism that allows a position change of the pair of attachment portions with respect to the body portion in the vehicle width direction in a state where the body portion and the pair of attachment portions are not fastened by the fastening portion, and supports the pair of attachment portions with respect to the body portion by restricting the position change of the pair of attachment portions with respect to the body portion in a direction different from the vehicle width direction.

According to the above configuration, in the state where the main body portion and the attachment portions are not fastened by the fastening portion, the exterior member is attached to the main body portion, and the pair of headlamps are attached to the pair of attachment portions, respectively. Further, the support mechanism allows the position change of the attachment portions with respect to the main body portion in the vehicle width direction, and restricts the position change of the attachment portions with respect to the main body portion in a front-rear direction of the vehicle, so that the headlamps can be moved toward the exterior member from the outside in the vehicle width direction. Accordingly, the second inclined surface of the headlamps can be brought into contact with the first inclined surface of the exterior member from the outside in the vehicle width direction. Further, the main body portion and the attachment portions are fastened by the fastening portion at the position where the first inclined surface and the second inclined surfaces are in contact with each other. In this way, the support member in a state where the main body portion and the attachment portions are fastened by the fastening portion is fixed to the vehicle body by the main body fixing portion. Therefore, an accuracy of assembling the exterior member and the headlamps is improved.

(2) The front structure of a vehicle according to (1), in which
the support mechanism includes:
   an elongated hole that is provided in one of the body portion and the pair of attachment portions and extends in the vehicle width direction;
   a hole that is provided in the other of the body portion and the pair of attachment portions;
   a bolt that is inserted into the elongated hole and the hole; and
   a nut that clamps the body portion and the pair of attachment portions in cooperation with the bolt.

According to the above configuration, the support mechanism includes the elongated hole provided in one of the main body portion and the attachment portions, the hole provided in the other of the main body portion and the attachment portions, the bolt, and the nut. Therefore, the support mechanism can be implemented by a simple configuration.

(3) The front structure of a vehicle according to (2), in which
each of the pair of attachment portions includes:
   an attachment portion body; and
   at least one connection portion that protrudes from the attachment portion body toward the body portion in the vehicle width direction,
the body portion includes at least one guide groove portion that opens to a side surface of the body portion and extends in the vehicle width direction, and to which the at least one connection portion is inserted,
the at least one guide groove portion is configured to guide movement of the at least one connection portion in the vehicle width direction by coming into contact with the at least one connection portion in the state where the body portion and the pair of attachment portions are not fastened by the fastening portion, and
the elongated hole is provided in the at least one guide groove portion.

According to the above configuration, the movement of the connection portion in the vehicle width direction is guided by the guide groove portion in the state where the main body portion and the attachment portions are not fastened by the fastening portion. Therefore, the second inclined surfaces of the headlamps can be easily brought into contact with the first inclined surface of the exterior member from the vehicle width direction. Therefore, the accuracy of assembling the exterior member and the headlamps is improved.

(4) The front structure of a vehicle according to (3), in which
a plurality of connection portions as the at least one connection portion and a plurality of guide groove portions as the at least one guide groove portions are spaced apart from each other in an up-down direction of the vehicle.

According to the above configuration, by providing the plurality of connection portions and the plurality of guide groove portions, it is possible to stabilize the position change of the attachment portions with respect to the main body portion in the vehicle width direction.

(5) A method for assembling the front structure of a vehicle according to any one of (1) to (4), the method including:
supporting the pair of attachment portions with respect to the body portion by the support mechanism;
attaching the exterior member to the body portion;
attaching the pair of headlamps to the pair of attachment portions;
bringing the first inclined surface and the second inclined surfaces into contact with each other by changing positions of the pair of attachment portions with respect to the body portion in the vehicle width direction;
fastening the pair of attachment portions to the body portion by the fastening portion; and
fixing the body portion to the vehicle body via the body fixing portion.

According to the above method, the same effects as those of the above (1) may be exerted.

According to the front structure of a vehicle and the method for assembling the same according to the present invention, the accuracy of assembling the exterior member and the headlamps may be improved.

### BRIEF DESCRIPTION OF DRAWINGS

Exemplary embodiment(s) of the present invention will be described in detail based on the following figures, wherein:

FIG. 1 is a front view showing a front structure of a vehicle according to an embodiment;

FIG. 2 is a front view showing a support member of FIG. 1;

FIG. 3 is an enlarged sectional view mainly showing an upper support mechanism of FIG. 2;

FIG. 4 is a plan view of the upper support mechanism of FIG. 3;

FIG. 5 is an enlarged sectional view mainly showing a lower support mechanism of FIG. 2;

FIG. 6 is a plan view of the front structure of a vehicle shown in FIG. 1;

FIG. 7 is a front view showing an exterior member and a headlamp attached to the support member in a state where a main body portion and an attachment portion are not fastened by a bolt; and

FIG. 8 is a front view showing the exterior member and the headlamp attached to the support member in a state where the main body portion and the attachment portion are fastened by the bolt.

### DESCRIPTION OF EMBODIMENTS

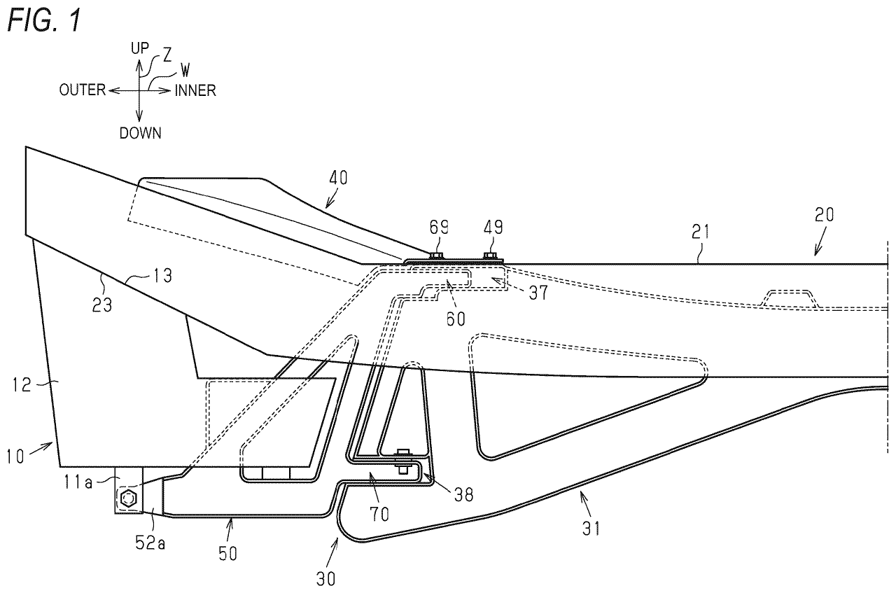

Hereinafter, an embodiment of a front structure of a vehicle and a method for assembling the front structure of a vehicle will be described with reference to FIGS. 1 to 8.

In the following description, a front-rear direction of the vehicle is referred to as a front-rear direction L, a vehicle width direction is referred to as a vehicle width direction W, and an up-down direction of the vehicle when the vehicle is located on a horizontal plane is referred to as an up-down direction Z. In the following description, front and rear in the front-rear direction L are simply referred to as front and rear, respectively, and inner and outer in the vehicle width direction W are simply referred to as inner and outer, respectively.

The front structure of a vehicle according to the present embodiment has a symmetrical structure in the vehicle width direction W. Therefore, hereinafter, a left half of a front portion of the vehicle when viewed from the front to the rear will be described, and a description for a right half is omitted.

As shown in FIG. 1, the front structure of a vehicle includes a pair of headlamps 10 provided apart from each other in the vehicle width direction W, an exterior member 20 provided between the pair of headlamps 10, and a support member 30 located behind the exterior member 20.

### <Support Member 30>

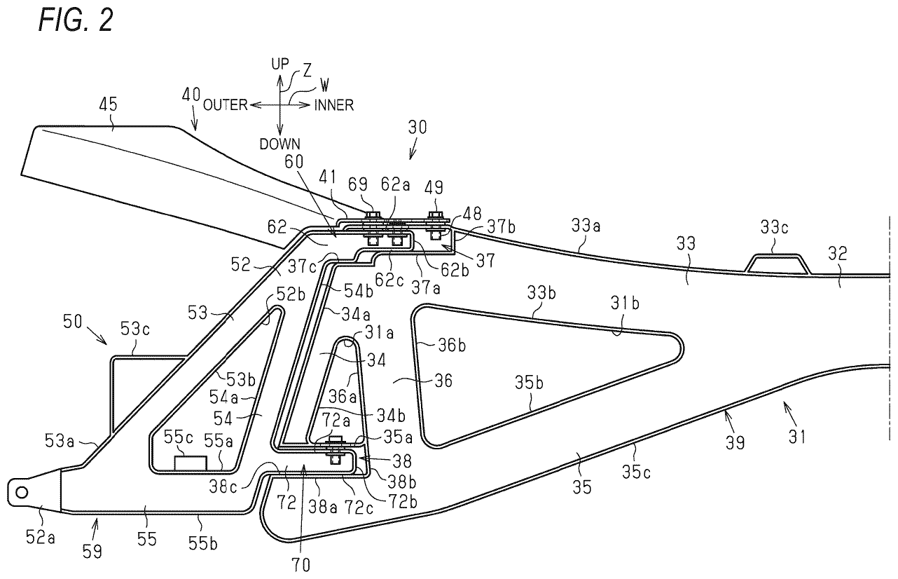

As shown in FIG. 2, the support member 30 includes a main body portion 31, a main body fixing portion 40, a pair of attachment portions 50, and a bolt 69.

In the present embodiment, the main body portion 31, the main body fixing portion 40, and the pair of attachment portions 50 are made of resin. The main body portion 31, the main body fixing portion 40, and the pair of attachment portions 50 may be made of metal.

### <Main Body Portion 31>

As shown in FIG. 2, the main body portion 31 is located at the center in the vehicle width direction W, and includes a plate-shaped main body side base portion 32, a peripheral wall portion 39, an upper guide groove portion 37, and a lower guide groove portion 38.

The main body side base portion 32 includes an upper portion 33 extending in the vehicle width direction W, a pair of side portions 34 extending downward from both ends of the upper portion 33 in the vehicle width direction W, a pair of lower portions 35 extending from lower ends of the side portions 34 toward the center of the upper portion 33 in the vehicle width direction W, and a pair of intermediate portions 36.

The upper portion 33 is curved such that a portion is located more downward toward the center in the vehicle width direction W.

Each of the side portions 34 is inclined such that a portion is located more downward toward the outer side.

Each of the lower portions 35 is connected to the center of the upper portion 33 in the vehicle width direction W, and is inclined such that a portion is located more upward toward the inner side.

Each of the intermediate portions 36 is located more inward than the side portion 34 and extends toward the lower portion 35 from a connection portion between the upper portion 33 and the side portion 34. The intermediate portion 36 is connected to the lower portion 35, and is inclined such that a portion is located more downward toward the inner side.

The peripheral wall portion 39 includes an upper portion upper wall 33a protruding forward from an upper edge of the upper portion 33, a side portion outer wall 34a protruding forward from an outer edge of the side portion 34, and a lower portion lower wall 35c protruding forward from a lower edge of the lower portion 35.

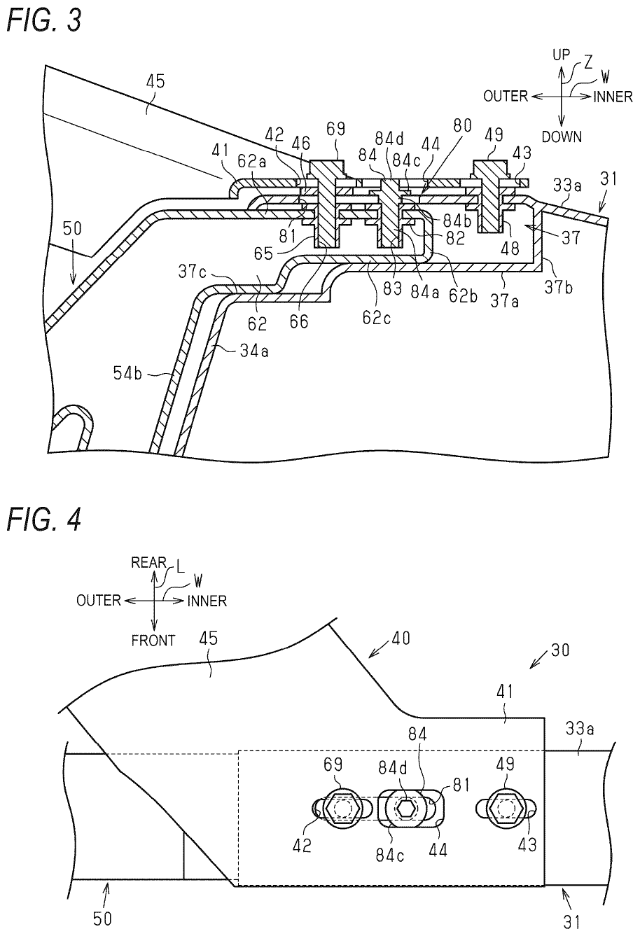

As shown in FIGS. 3 and 4, an elongated hole 81 that penetrates the upper portion upper wall 33a in the up-down direction Z and is long in the vehicle width direction W is provided at an end portion of the upper portion upper wall 33a in the vehicle width direction W.

As shown in FIG. 3, a nut 48 is provided, side by side with the elongated hole 81, in a portion of the upper portion upper wall 33a that is more inward than the elongated hole 81 in the vehicle width direction W. The nut 48 is provided with a groove portion that clamps the upper portion upper wall 33a in the up-down direction Z.

As shown in FIG. 2, at the center of the upper portion upper wall 33a in the vehicle width direction W, a pair of attachment pieces 33c to which the exterior member 20 is attached are spaced apart from each other in the vehicle width direction W.

The side portion outer wall 34a is provided with an upper notch 37c and a lower notch 38c that is located lower than the upper notch 37c. The upper notch 37c and the lower notch 38c are spaced apart from each other in the up-down direction Z, and open forward in the vehicle width direction W.

The upper notch 37c is provided at an upper end of the side portion outer wall 34a.

In the main body side base portion 32, a through hole 31a is formed by a side portion inner wall 34b protruding forward from an inner edge of the side portion 34, an intermediate outer wall 36a protruding forward from an outer edge of the intermediate portion 36, and a first lower portion upper wall 35a.

The first lower portion upper wall 35a extends along the vehicle width direction W and connects an upper edge of the lower notch 38c, a lower edge of the side portion inner wall 34b, and a lower edge of the intermediate outer wall 36a.

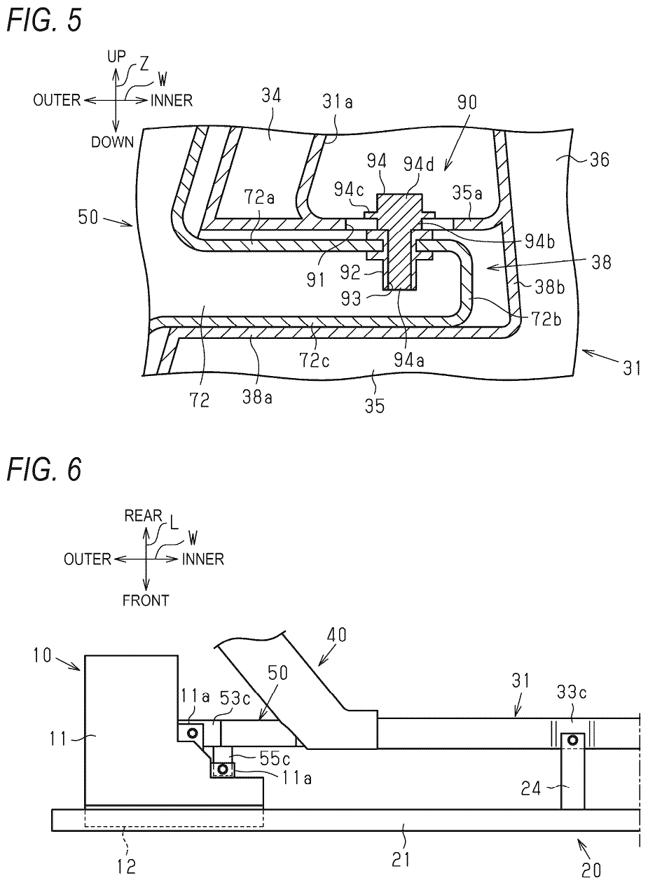

A portion of the first lower portion upper wall 35a located between the side portion 34 and the intermediate portion 36 protrudes forward from an upper edge of the lower portion 35 located between the side portion 34 and the intermediate portion 36. An elongated hole 91 that penetrates the first lower portion upper wall 35a in the up-down direction Z and is long in the vehicle width direction W is provided in the portion of the first lower portion upper wall 35a located between the side portion 34 and the intermediate portion 36 (see FIG. 5).

The main body side base portion 32 is provided with a through hole 31b on a side opposite to the through hole 31a in the vehicle width direction W of the intermediate portion 36. The through hole 31b is formed by an upper portion lower wall 33b protruding forward from a lower edge of the upper portion 33, an intermediate inner wall 36b protruding forward from an inner edge of the intermediate portion 36, and a second lower portion upper wall 35b protruding forward from a portion of the upper edge of the lower portion 35 that is located more inward than the intermediate portion 36.

An upper support wall 37a and an upper side wall 37b located below the end portion of the upper portion upper wall 33a in the vehicle width direction W protrude from a front surface of the main body portion 31.

The upper side wall 37b is located more inward than the nut 48, extends along the up-down direction Z, and is connected to the upper portion upper wall 33a.

The upper support wall 37a connects a lower edge of the upper side wall 37b and a lower edge of the upper notch 37c and extends in the vehicle width direction W. The upper support wall 37a has an enlarged portion extending from the lower edge of the upper notch 37c and a reduced portion located closer to the upper portion upper wall 33a than the enlarged portion.

The main body side base portion 32, the upper portion upper wall 33a, the upper side wall 37b, the upper support wall 37a, and the upper notch 37c constitute the upper guide groove portion 37.

A lower support wall 38a and a lower side wall 38b located below the first lower portion upper wall 35a protrude from the front surface of the main body portion 31.

The lower side wall 38b is connected to a connection portion between the intermediate outer wall 36a and the first lower portion upper wall 35a and extends in the up-down direction Z.

The lower support wall 38a connects a lower edge of the lower side wall 38b and a lower edge of the lower notch 38c and extends along the vehicle width direction W.

The main body side base portion 32, the first lower portion upper wall 35a, the lower side wall 38b, the lower support wall 38a, and the lower notch 38c constitute the lower guide groove portion 38.

In the present embodiment, the side portion outer wall 34a corresponds to a side surface of the main body portion according to the present invention.

### <Attachment Portion 50>

As shown in FIG. 2, the pair of attachment portions 50 are connected to both ends of the main body portion 31 in the vehicle width direction W.

Each of the attachment portions 50 includes a plate-shaped attachment side base portion 52 and a peripheral wall portion 59.

The attachment side base portion 52 includes a first side portion 54, a second side portion 53, a lower portion 55, an upper connection base portion 62, and a lower connection base portion 72.

The first side portion 54 is adjacent to the side portion 34 in the vehicle width direction W and extends in the up-down direction Z along the side portion 34.

The second side portion 53 extends toward the outer side from an upper end of the first side portion 54, and is inclined such that a portion is located more downward toward the outer side.

The lower portion 55 connects a lower end of the first side portion 54 and a lower end of the second side portion 53, extends along the vehicle width direction W, and extends more outward in the vehicle width direction W than the lower end of the second side portion 53.

An outer end portion of the lower portion 55 is provided with an attachment piece 52a to which the headlamp 10 is attached.

The upper connection base portion 62 protrudes from the upper end of the first side portion 54 toward the main body portion 31 in the vehicle width direction W and is inserted into the upper guide groove portion 37.

An upper edge of the upper connection base portion 62 extends along the end portion of the upper portion upper wall 33a in the vehicle width direction W.

A tip of the upper connection base portion 62 is spaced apart from the upper side wall 37b in the vehicle width direction W.

A lower edge of the upper connection base portion 62 includes an enlarged portion extending from the first side portion 54 along the vehicle width direction W and a reduced portion located closer to the upper portion upper wall 33a than the enlarged portion.

The lower connection base portion 72 protrudes toward the main body portion 31 in the vehicle width direction W from a portion of the first side portion 54 that is lower than the upper connection base portion 62, and is inserted into the lower guide groove portion 38.

An upper edge of the lower connection base portion 72 extends along the first lower portion upper wall 35a.

A tip of the lower connection base portion 72 is spaced apart from the lower side wall 38b in the vehicle width direction W.

The lower edge of the lower connection base portion 72 extends along the lower support wall 38a.

The peripheral wall portion 59 has a first side portion inner wall 54b protruding forward from an inner edge of the first side portion 54, a second side portion outer wall 53a protruding forward from an outer edge of the second side portion 53, and a lower portion lower wall 55b protruding forward from a lower edge of the lower portion 55. The peripheral wall portion 59 includes an upper wall portion 62a protruding forward from the upper edge of the upper connection base portion 62, a side wall portion 62b protruding forward from a tip edge of the upper connection base portion 62, and a lower wall portion 62c protruding forward from the lower edge of the upper connection base portion 62. The peripheral wall portion 59 includes an upper wall portion 72a protruding forward from the upper edge of the lower connection base portion 72, a side wall portion 72b protruding forward from a tip edge of the lower connection base portion 72, and a lower wall portion 72c protruding forward from the lower edge of the lower connection base portion 72.

The second side portion outer wall 53a is provided with an attachment piece 53c that protrudes outward in the vehicle width direction W and to which the headlamp 10 is attached.

In the attachment side base portion 52, a through hole 52b is formed by a first side portion outer wall 54a protruding forward from an outer edge of the first side portion 54, a second side portion inner wall 53b protruding forward from an inner edge of the second side portion 53, and a lower portion upper wall 55a protruding forward from an upper edge of the lower portion 55.

The lower portion upper wall 55a is provided with an attachment piece 55c that protrudes upward and to which the headlamp 10 is attached.

The side wall portion 62b is located more outward than the nut 48.

The lower wall portion 62c is supported from below by the upper support wall 37a.

The side wall portion 72b is located more outward than the lower side wall 38b.

The lower wall portion 72c is supported from below by the lower support wall 38a.

The upper connection base portion 62, the upper wall portion 62a, the side wall portion 62b, and the lower wall portion 62c constitute an upper connection portion 60.

The lower connection base portion 72, the upper wall portion 72a, the side wall portion 72b, and the lower wall portion 72c constitute a lower connection portion 70.

As shown in FIG. 3, the nut 65 and the nut 82 are provided side by side in order from the outer side in the vehicle width direction W on the upper wall portion 62a.

The nut 65 and the nut 82 are located below the elongated hole 81. The nut 65 and the nut 82 are each provided with a groove portion that clamps the upper wall portion 62a from the up-down direction Z.

A hole 66 of the nut 65 and a hole 83 of the nut 82 communicate with the elongated hole 81 in the up-down direction Z.

A bolt 84 that clamps the main body portion 31 and the attachment portion 50 in cooperation with the nut 82 is fastened to the hole 83 of the nut 82 and the elongated hole 81. The bolt 84 is a so-called stepped bolt including a shaft portion 84a screwed into the nut 82, an enlarged diameter portion 84b having a diameter larger than that of the shaft portion 84a, a flange portion 84c having a diameter enlarged outward from an upper end of the enlarged diameter portion 84b, and a head portion 84d protruding upward from the flange portion 84c.

The enlarged diameter portion 84b restricts the bolt 84 from entering the nut 82 by coming into contact with the nut 82. A width of the enlarged diameter portion 84b in the front-rear direction L is substantially the same as a width of the elongated hole 81 in the front-rear direction L.

The flange portion 84c extends more outward than an edge of the elongated hole 81 on both sides in the front-rear direction L (see FIG. 4). A portion of the upper portion upper wall 33a around the elongated hole 81 is loosely clamped between the flange portion 84c and the nut 82.

A nut 92 located below the elongated hole 91 is insert-molded in the upper wall portion 72a. The elongated hole 91 is provided with a groove portion that clamps the upper wall portion 72a in the up-down direction Z.

The hole 93 of the nut 92 communicates with the elongated hole 91 from the up-down direction Z.

A bolt 94 that clamps the main body portion 31 and the attachment portion 50 in cooperation with the nut 92 is fastened to the hole 93 of the nut 92 and the elongated hole 91. The bolt 94 is a so-called stepped bolt including a shaft portion 94a screwed into the nut 92, an enlarged diameter portion 94b having a diameter larger than that of the shaft portion 94a, a flange portion 94c having a diameter enlarged outward from an upper end of the enlarged diameter portion 94b, and a head portion 94d protruding upward from the flange portion 94c.

The enlarged diameter portion 94b restricts the bolt 94 from entering the nut 92 by coming into contact with the nut 92. A width of the enlarged diameter portion 94b in the front-rear direction L is substantially the same as a width of the elongated hole 91 in the front-rear direction L.

The flange portion 94c extends more outward than an edge of the elongated hole 91 on both sides in the front-rear direction L. A portion of the first lower portion upper wall 35a around the elongated hole 91 is loosely clamped between the flange portion 94c and the nut 92.

### <Main Body Fixing Portions 40 and Bolt 69>

As shown in FIG. 2, the pair of main body fixing portions 40 fix the main body portion 31 to a vehicle body (not shown).

Each of the main body fixing portions 40 includes a front end portion 41 located adjacent to the upper side of the end portion of the upper portion upper wall 33a in the vehicle width direction W, and an extension portion 45 extending outward and rearward from the front end portion 41.

As shown in FIGS. 3 and 4, the front end portion 41 has an elongated hole 43 communicating with the nut 48 in the up-down direction Z, an elongated hole 42 communicating with the elongated hole 81 and the nut 65 in the up-down direction Z, and an elongated hole 44 communicating with the elongated hole 81 and the nut 82 in the up-down direction Z.

An annular member 46 having an annular shape and communicating with the elongated hole 42 and the elongated hole 81 is provided between the front end portion 41 and the upper portion upper wall 33a in the up-down direction Z.

The main body portion 31 and the front end portion 41 are fixed to each other by screwing, into the nut 48, the bolt 49 inserted into the elongated hole 43.

The attachment portion 50, the main body portion 31, the annular member 46, and the front end portion 41 are fixed to each other by screwing, into the nut 65, the bolt 69 inserted into the elongated hole 42, the elongated hole 81, and the annular member 46.

The head portion 84d of the bolt 84 is inserted into the elongated hole 44.

A rear end of the extension portion 45 is fastened to the vehicle body by a bolt.

In the present embodiment, the bolt 69 corresponds to a fastening portion according to the present invention. In the present embodiment, the first side portion 54, the second side portion 53, and the lower portion 55 correspond to an attachment portion main body according to the present invention.

### <Headlamps 10>

As shown in FIG. 6, each of the headlamps 10 includes a housing 11 that opens forward and a transparent cover 12 that covers the opening of the housing 11.

The housing 11 accommodates a light source (not shown) therein. As the light source, for example, a headlight, an indicator lamp, an illumination light, a projector, and a daytime lamp can be used alone or in combination.

As shown in FIGS. 1 and 6, the housing 11 includes a plurality of attachment pieces 11a that are provided at positions corresponding to the attachment pieces 52a, 53c, and 55c, respectively, and to which the attachment portion 50 is fastened by a bolt.

As shown in FIG. 1, an upper surface of the cover 12 is provided with a second inclined surface 13 that is inclined such that a portion is located more upward toward the outer side.

### <Exterior Member 20>

As shown in FIG. 1, the exterior member 20 is attached to the main body portion 31 and constitutes a part of the front surface of the vehicle. The exterior member 20 is, for example, a front garnish.

As shown in FIG. 6, the exterior member 20 includes an exterior member main body 21 located in front of the main body portion 31 and a pair of protruding portions 24 protruding rearward from a back surface of the exterior member main body 21.

The exterior member 20 is attached to the main body portion 31 by attaching a rear end of the protruding portion 24 to the attachment piece 33c with a bolt.

As shown in FIG. 1, the exterior member main body 21 extends in the vehicle width direction W and is in contact with the pair of headlamps 10 in the vehicle width direction W.

A lower surface of the exterior member main body 21 is provided with a first inclined surface 23 that comes into contact with the headlamp 10 in the vehicle width direction W and is inclined along the second inclined surface 13.

The exterior member main body 21 is integrally made of a hard resin.

### <Method for Assembling Front Structure of Vehicle>

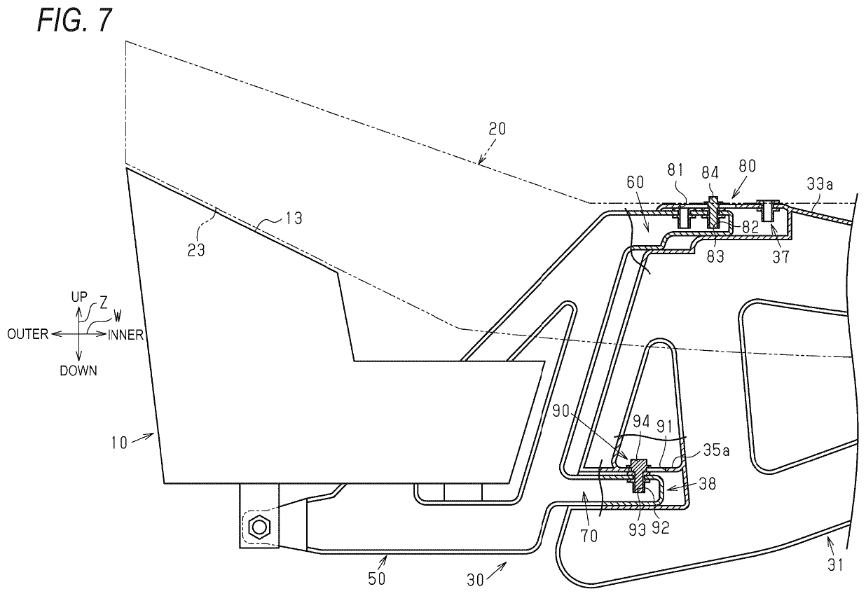

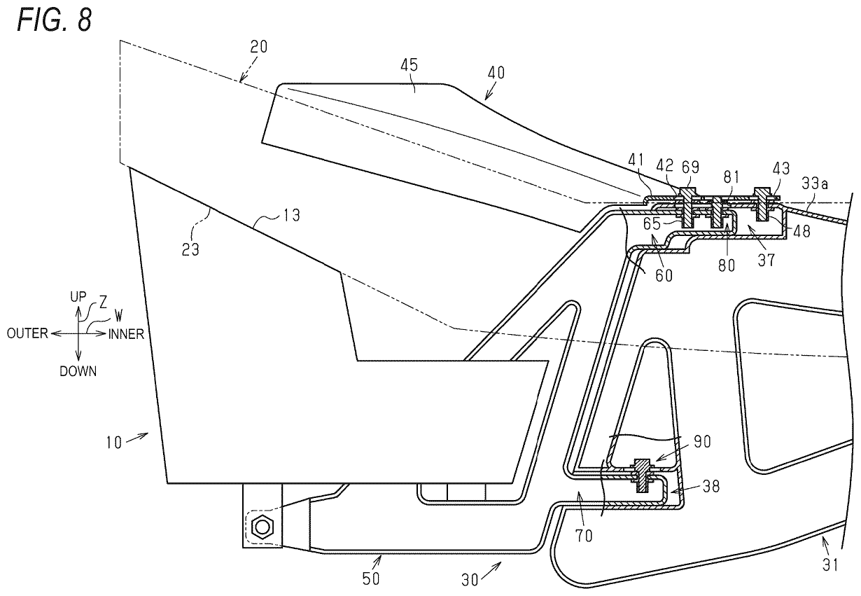

As shown in FIGS. 7 and 8, a method for assembling the front structure of a vehicle includes an attachment portion supporting step, an exterior member attaching step, a headlamp attaching step, a position changing step, a fastening step, and a main body portion fixing step.

### <Attachment Portion Supporting Step>

As shown in FIG. 7, first, in the attachment portion supporting step, the upper connection portion 60 and the lower connection portion 70 of the attachment portion 50 are respectively inserted into the upper guide groove portion 37 and the lower guide groove portion 38 of the main body portion 31.

Next, the bolt 84 inserted into the elongated hole 81 is screwed into the hole 83 of the nut 82, so that the upper connection portion 60 is supported with respect to the upper portion upper wall 33a. Further, the bolt 94 inserted into the elongated hole 91 is screwed into the hole 93 of the nut 92, so that the lower connection portion 70 is supported with respect to the first lower portion upper wall 35a. In this way, the attachment portion 50 is supported with respect to the main body portion 31 by the upper support mechanism 80 and the lower support mechanism 90.

The upper support mechanism 80 and the lower support mechanism 90 support the attachment portion 50 with respect to the main body portion 31 while allowing a position change of the attachment portion 50 with respect to the main body portion 31 in the vehicle width direction W in a state where the main body portion 31 and the attachment portion 50 are not fastened by the bolt 69. On the other hand, the upper support mechanism 80 and the lower support mechanism 90 support the attachment portion 50 with respect to the main body portion 31 by restricting the position change of the attachment portion 50 with respect to the main body portion 31 in a direction different from the vehicle width direction W, that is, the front-rear direction L and the up-down direction Z. The elongated hole 81 allows a position change of the bolt 84 in the vehicle width direction W, and restricts the position change of the bolt 84 in the front-rear direction L. In addition, the elongated hole 91 allows a position change of the bolt 94 in the vehicle width direction W, and restricts a position displacement of the bolt 94 in the front-rear direction L. Further, the bolt 84 and the nut 82, and the bolt 94 and the nut 92 restrict the position change of the attachment portion 50 with respect to the main body portion 31 in the up-down direction Z.

The upper guide groove portion 37 is configured to guide movement of the upper connection portion 60 in the vehicle width direction W by coming into contact with the upper connection portion 60 in the state where the main body portion 31 and the attachment portion 50 are not fastened by the bolt 69. The lower guide groove portion 38 is configured to guide movement of the lower connection portion 70 in the vehicle width direction W by coming into contact with the lower connection portion 70 in the state where the main body portion 31 and the attachment portion 50 are not fastened by the bolt 69.

### <Exterior Member Attaching Step>

As indicated by a two-dot chain line in FIG. 7, in the exterior member attaching step, the exterior member 20 is disposed in front of the main body portion 31, and the exterior member 20 is attached to the main body portion 31.

### <Headlamp Attaching Step>

As shown in FIG. 7, in the headlamp attaching step, the headlamp 10 is disposed in front of the attachment portion 50, and the headlamp 10 is attached to the attachment portion 50.

In this case, the attachment portion 50 is moved outward to a position where the outward movement of the bolt 94 is restricted by an outer end portion of the elongated hole 91 in the vehicle width direction W. Therefore, a gap is formed between the first inclined surface 23 and the second inclined surface 13 in the vehicle width direction W.

### <Position Changing Step>

As shown in FIG. 8, in the position changing step, the first inclined surface 23 and the second inclined surface 13 are brought into contact with each other by changing a position of the attachment portion 50 with respect to the main body portion 31 in the vehicle width direction W. That is, the first inclined surface 23 and the second inclined surface 13 come into contact with each other by moving the headlamp 10 inward in the vehicle width direction W, that is, toward the exterior member 20.

### <Fastening Step>

As shown in FIG. 8, in the fastening step, the attachment portion 50 is fastened to the main body portion 31 by the bolt 69.

In the fastening step, first, the front end portion 41 of the main body fixing portion 40 is superimposed on the upper portion upper wall 33a of the main body portion 31 such that the elongated hole 42, the elongated hole 81, and the nut 65 are superimposed on the elongated hole 43 and the nut 48, respectively.

Next, the attachment portion 50 is fastened to the main body portion 31 by the bolt 69 at a position where the first inclined surface 23 and the second inclined surface 13 are in contact with each other. In this case, the main body fixing portion 40 is further fixed to the main body portion 31 by the bolt 69.

### <Main Body Portion Fixing Step>

As shown in FIG. 8, in the main body portion fixing step, the main body portion 31 is fixed to the vehicle body via the main body fixing portion 40 by fastening the rear end of the extension portion 45 of the main body fixing portion 40 to the vehicle body (both not shown) with a bolt.

### Operations of Present Embodiment

As shown in FIG. 7, in the state where the main body portion 31 and the attachment portion 50 are not fastened by the bolt 69, the exterior member 20 is attached to the main body portion 31, and the headlamp 10 is attached to the attachment portion 50. Each of the support mechanisms 80 and 90 allows the position change of the attachment portion 50 with respect to the main body portion 31 in the vehicle width direction W, and restricts the position change of the attachment portion 50 with respect to the main body portion 31 in a direction different from the vehicle width direction W. Therefore, the headlamp 10 can be moved from the outer side in the vehicle width direction W toward the exterior member 20. Accordingly, the second inclined surface 13 of the headlamp 10 can be brought into contact with the first inclined surface 23 of the exterior member 20 from the outside in the vehicle width direction W. The main body portion 31 and the attachment portion 50 are fastened by the bolt 69 at the position where the first inclined surface 23 and the second inclined surface 13 are in contact with each other. In this way, the support member 30 in a state where the main body portion 31 and the attachment portion 50 are fastened by the bolt 69 is fixed to the vehicle body (not shown) by the main body fixing portion 40.

### Effects of Present Embodiment

(1) Each of the support mechanisms 80 and 90 allows the position change of the attachment portion 50 with respect to the main body portion 31 in the vehicle width direction W in the state where the main body portion 31 and the attachment portion 50 are not fastened by the bolt 69. On the other hand, each of the support mechanisms 80 and 90 supports the attachment portion 50 with respect to the main body portion 31 by restricting the position change of the attachment portion 50 with respect to the main body portion 31 in a direction different from the vehicle width direction W.

According to such a configuration, since the above operations are exhibited, an accuracy of assembling the exterior member 20 and the headlamp 10 is improved.

(2) The upper support mechanism 80 includes the elongated hole 81 provided in the main body portion 31, the hole 83 provided in the attachment portion 50, the bolt 84 inserted into the elongated hole 81 and the hole 83, and the nut 82. The lower support mechanism 90 includes the elongated hole 91 provided in the main body portion 31, the hole 93 provided in the attachment portion 50, the bolt 94 inserted into the elongated hole 81 and the hole 83, and the nut 92.

According to such a configuration, the support mechanisms 80 and 90 are respectively configured by the elongated holes 81 and 91 provided in the main body portion 31, the holes 83 and 93 provided in the attachment portion 50, the bolts 84 and 94, and the nuts 82 and 92. Therefore, the support mechanisms 80 and 90 can be implemented by a simple configuration.

(3) The upper guide groove portion 37 is configured to guide the movement of the upper connection portion 60 in the vehicle width direction W by coming into contact with the upper connection portion 60 in the state where the main body portion 31 and the attachment portion 50 are not fastened by the bolt 69. The same applies to the lower guide groove portion 38 and the lower connection portion 70.

According to such a configuration, the movement of the upper connection portion 60 in the vehicle width direction W is guided by the upper guide groove portion 37 in the state where the main body portion 31 and the attachment portion 50 are not fastened by the bolt 69. Therefore, the second inclined surface 13 of the headlamp 10 can be easily brought into contact with the first inclined surface 23 of the exterior member 20 from the vehicle width direction W. Therefore, the accuracy of assembling the exterior member 20 and the headlamp 10 is improved.

(4) The upper connection portion 60 and the upper guide groove portion 37 are spaced apart from each other in the up-down direction Z, and the lower connection portion 70 and the lower guide groove portion 38 are spaced apart from each other in the up-down direction Z.

According to such a configuration, by providing the plurality of connection portions and the plurality of guide groove portions, the position change of the attachment portion 50 with respect to the main body portion 31 in the vehicle width direction W can be stabilized.

(5) The method for assembling the front structure of a vehicle includes the attachment portion supporting step, the exterior member attaching step, the headlamp attaching step, the position changing step, the fastening step, and the main body portion fixing step.

According to such a method, it is possible to achieve the same effects as the above effect (1).

### Modifications

The present embodiment can be modified and implemented as follows. The present embodiment and the following modifications can be combined with each other and implemented without technical contradiction.

In the above embodiment, the headlamp attaching step is performed after the exterior member attaching step, but the headlamp attaching step may be performed before the exterior member attaching step.

In the above embodiment, two connection portions are provided, that is, the upper connection portion 60 and the lower connection portion 70, and two guide groove portions are provided, that is, the upper guide groove portion 37 and the lower guide groove portion 38, but the number of the connection portions and the guide groove portions may be one or three or more.

In the above embodiment, the connection portion is inserted into the guide groove portion, but the present invention is not limited thereto. For example, the upper connection portion 60 may be provided on an upper surface of the end portion of the upper portion upper wall 33a in the vehicle width direction W. In this case, the upper connection portion 60 may be supported by the support mechanism with respect to the end portion of the upper portion upper wall 33a in the vehicle width direction W.

If the attachment portion 50 is supported by the support mechanism with respect to the main body portion 31, the guide groove portion may be omitted.

A position of the elongated hole 81 constituting the upper support mechanism 80 may be appropriately changed as long as the elongated hole 81 becomes a peripheral wall constituting the upper guide groove portion 37, and the elongated hole 81 may be an elongated hole penetrating the main body side base portion 32 in the front-rear direction L. Similarly, a position of the elongated hole 91 constituting the lower support mechanism 90 may be appropriately changed as long as the elongated hole 91 becomes a peripheral wall constituting the lower guide groove portion 38.

In the above embodiment, the support mechanisms 80 and 90 are implemented by the bolts 84 and 94 inserted into the elongated holes 81 and 91, but the prevent invention is not limited thereto. For example, an elongated hole may be provided in the main body portion 31, and a protruding portion inserted into the elongated hole may be provided in the attachment portion 50.

In the above embodiment, the elongated holes 81 and 91 are provided in the main body portion 31, and the holes 83 and 93 into which the bolts 84 and 94 are screwed are provided in the attachment portion 50, but the present invention is not limited thereto. The elongated holes 81 and 91 may be provided in the attachment portion 50, and the holes 83 and 93 into which the bolts 84 and 94 are screwed may be provided in the main body portion 31.

In the above embodiment, the attachment portion 50, the main body portion 31, and the main body fixing portion 40 are fixed by the bolt 69, but the present invention is not limited thereto. The attachment portion of the main body fixing portion 40 may be separately provided in the main body portion 31, and the attachment portion 50 and the main body portion 31 may be fixed by the bolt 69.

The first inclined surface 23 is not limited to being provided on the lower surface of the exterior member main body 21, and may be provided on an upper surface of the exterior member main body 21. That is, the first inclined surface 23 may be provided on the upper surface of the exterior member main body 21 and may be inclined such that a position located more downward toward the outer side in the vehicle width direction W. In this case, the second inclined surface 13 may be provided on a lower surface of the headlamp 10 and inclined along the first inclined surface 23. Also in this case, the first inclined surface 23 may be in contact with the second inclined surface 13 of the headlamp 10 in the vehicle width direction W.

What is claimed is:

1. A front structure of a vehicle comprising:
a pair of headlamps provided apart from each other in a vehicle width direction;
an exterior member provided between the pair of headlamps; and
a support member located at a vehicle rear of the exterior member and configured to allow the pair of headlamps and the exterior member to be attached, wherein
the exterior member has a first inclined surface that comes into contact with the pair of headlamps in the vehicle width direction,
each of the pair of headlamps has a second inclined surface that is inclined along the first inclined surface,
the first inclined surface is inclined such that a portion located more upward or more downward toward an outer side in the vehicle width direction,
the support member includes:
a body portion to which the exterior member is attached;
a body fixing portion that fixes the body portion to a vehicle body;
a pair of attachment portions that are connected to both ends of the body portion in the vehicle width direction and to which the pair of headlamps are attached; and
a fastening portion that fastens the attachment portions to the body portion at a position where the first inclined surface and the second inclined surfaces are in contact with each other, and
the support member includes a support mechanism that allows a position change of the pair of attachment portions with respect to the body portion in the vehicle width direction in a state where the body portion and the pair of attachment portions are not fastened by the fastening portion, and supports the pair of attachment portions with respect to the body portion by restricting the position change of the pair of attachment portions with respect to the body portion in a direction different from the vehicle width direction.

2. The front structure of a vehicle according to claim 1, wherein
the support mechanism includes:
an elongated hole that is provided in one of the body portion and the pair of attachment portions and extends in the vehicle width direction;
a hole that is provided in the other of the body portion and the pair of attachment portions;
a bolt that is inserted into the elongated hole and the hole; and
a nut that clamps the body portion and the pair of attachment portions in cooperation with the bolt.

3. The front structure of a vehicle according to claim 2, wherein
each of the pair of attachment portions includes:
an attachment portion body; and
at least one connection portion that protrudes from the attachment portion body toward the body portion in the vehicle width direction,
the body portion includes at least one guide groove portion that opens to a side surface of the body portion and extends in the vehicle width direction, and to which the at least one connection portion is inserted,
the at least one guide groove portion is configured to guide movement of the at least one connection portion in the vehicle width direction by coming into contact with the at least one connection portion in the state where the body portion and the pair of attachment portions are not fastened by the fastening portion, and
the elongated hole is provided in the at least one guide groove portion.

4. The front structure of a vehicle according to claim 3, wherein
a plurality of connection portions as the at least one connection portion and a plurality of guide groove portions as the at least one guide groove portions are spaced apart from each other in an up-down direction of the vehicle.

5. A method for assembling the front structure of a vehicle according to claim 1, the method comprising:
supporting the pair of attachment portions with respect to the body portion by the support mechanism;
attaching the exterior member to the body portion;
attaching the pair of headlamps to the pair of attachment portions;
bringing the first inclined surface and the second inclined surfaces into contact with each other by changing positions of the pair of attachment portions with respect to the body portion in the vehicle width direction;
fastening the pair of attachment portions to the body portion by the fastening portion; and
fixing the body portion to the vehicle body via the body fixing portion.
